(19) United States
(12) Patent Application Publication
(10) Pub. No.: US 2008/0178592 A1
(43) Pub. Date: Jul. 31, 2008

(54) PRE-CLEANER ASPIRATION SYSTEM

(76) Inventor: Christopher Adam Bering, Waterloo, IA (US)

Correspondence Address: DEERE & COMPANY, ONE JOHN DEERE PLACE, MOLINE, IL, 61265, US

(21) Appl. No.: 11/626,873

(22) Filed: Jan. 25, 2007

(51) Int. Cl. F02B 33/44

(52) U.S. Cl. 60/605.1; 60/614

(57) ABSTRACT

The invention relates to an engine air intake system. There is a need for a simple and low cost device for aspirating a pre-cleaner in an engine air intake system. The system includes a pre-cleaner aspiration system for an engine intake air system having a turbo-compressor with a turbine and a compressor, a pre-cleaner and a filter. The aspiration system includes an air amplifier having an inlet, a throat, a nozzle in the throat, and an outlet. A first line communicates the inlet to a dirty air outlet of the pre-cleaner. A second line communicates compressed air from the compressor to the nozzle. The nozzle injects compressed air into the throat and creating a suction which is communicated to the pre-cleaner via the first line.

### FIELD OF THE INVENTION

The present invention relates to an engine intake air system.

### BACKGROUND OF THE INVENTION

Air used in the combustion process of an internal combustion engine must be clean. For this purpose, off-road vehicles require intake air to pass through a pre-cleaner and a filter. Such a pre-cleaner typically includes vortex tubes that separate debris from the air. This debris must be collected and removed on a continuous basis. The process of removing the debris is referred to as aspiration and has typically been done using suction from the cooling system fan or with an exhaust venturi. A simple, low cost alternative system for aspirating the precleaner is desired.

### SUMMARY OF THE INVENTION

Accordingly, an object of this invention is to provide a simple and low cost system for improving aspiration of an engine air pre-cleaner.

A further object of the invention is to provide such a system which does not require any moving parts.

A further object of the invention is to provide such a system wherein the rate of aspiration is proportional to the speed and load of the engine.

These and other objects are achieved by the present invention, wherein an engine intake air system has a turbo-compressor with a turbine and a compressor, a pre-cleaner and a filter. The pre-cleaner has a dirty air outlet. Intake air flows to the compressor through the pre-cleaner and the filter. A compressed air line communicates compressed air from the compressor to a charge air cooler. The air amplifier has an inlet, a throat, nozzles in the throat and connected to the port, and an outlet. A first line communicates the inlet to the pre-cleaner dirty air outlet, and a second line communicates the port to the compressed air line. The nozzles inject compressed air into the throat and create a suction which is communicated to the pre-cleaner via the first line. This system eliminates all moving parts from the aspiration system, and the rate of aspiration is proportional to the speed and load of the engine.

### BRIEF DESCRIPTION OF THE DRAWINGS

FIG. 1 is a simplified schematic diagram of the present invention; and

FIG. 2 is a sectional view of the pre-cleaner and the air amplifier of FIG. 1.

### DESCRIPTION OF THE PREFERRED EMBODIMENT

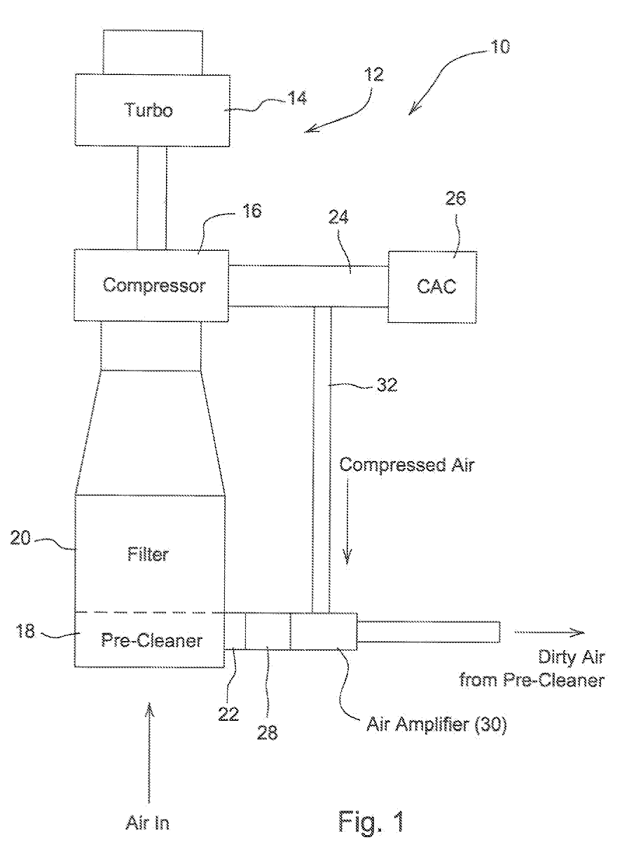

Referring to FIG. 1, an engine intake air system 10 includes a turbo-compressor 12 with a turbine 14 and a compressor 16, a pre-cleaner 18 and a filter 20. Engine intake air flows through the pre-cleaner 18, through the filter 20 and into the compressor 16. The pre-cleaner 18 has a dirty air outlet 22. A compressed air line 24 communicates compressed air from the compressor 16 to a charge air cooler 26. A line 28 communicates dirty air from outlet 22 to an inlet of an air amplifier 30. A compressed air line 32 communicates compressed air from line 24 to a port 25 on the air amplifier 30.

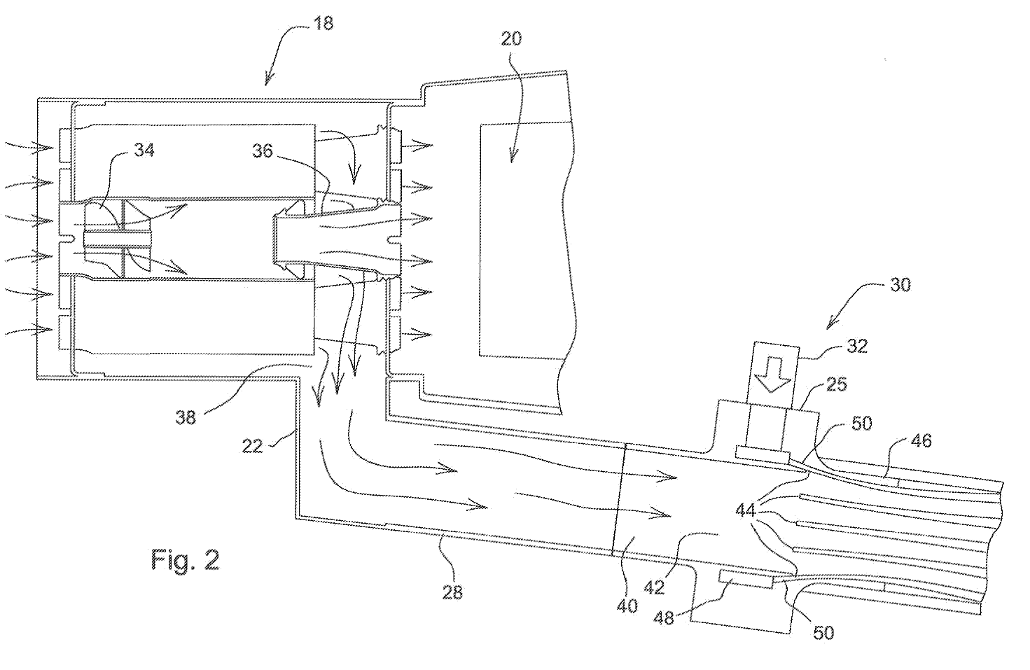

As best seen in FIG. 2, the pre-cleaner 18 is a conventional pre-cleaner and has a plurality of helical vanes 34 which swirl the air flowing through the pre-cleaner 18 and cause dirt and debris particles to be impelled radially outwardly so that only relatively cleaner air tends to flow through the inner tubes 36 and on into the filter 20. The relatively dirty air follows into a chamber 38 which is connected to dirty air outlet 22.

The air amplifier 30 is a conventional commercially available device, and has an inlet 40, a narrower throat 42, the inlet port 25, a plurality of nozzles 44 in the throat 42, and an outlet 46. The inlet 40 is connected to the pre-cleaner dirty air outlet 22 by line 28. The nozzles 44 are communicated with inlet port 25 and compressed air line 32 by an annular chamber 48 and a plurality of passages 50. The nozzles 44 inject compressed air into the throat 42 and create a suction which is communicated to the pre-cleaner outlet 22 via line 28. This suction aids in the extraction of dirty air from the pre-cleaner 18.

The nozzles 44 inject small amounts of compressed air into the throat 42 at velocities approaching the speed of sound. This creates a vacuum in the throat converging section, thereby amplifying the flow of air from the pre-cleaner outlet 22 and through the air amplifier 30. Thus, the air amplifier 30 will aspirate the pre-cleaner 18. By using a small amount of compressed air (after the turbo compressor 16), the air amplifier may be closely coupled to the air filter 20. This system eliminates all moving parts from the aspiration system, and the rate of aspiration is proportional to the speed and load of the engine, which is beneficial for the operation of the pre-cleaner 18. This system also results in a compact and low cost assembly of components with efficient routing of lines.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. An engine intake air system having a turbo-compressor with a turbine and a compressor, a pre-cleaner and a filter, the pre-cleaner having a dirty air outlet, intake air flowing to the compressor through the pre-cleaner and the filter, a compressed air line communicating compressed air out of the compressor, characterized by:
an air amplifier having an inlet, a throat, a nozzle in the throat, and an outlet, a first line communicating the inlet to the pre-cleaner dirty air outlet, and a second line communicating the nozzle to the compressed air line, the nozzle injecting compressed air into the throat and creating a suction which is communicated to the pre-cleaner via the first line.

2. A pre-cleaner aspiration system for an engine intake air system having a turbo-compressor with a turbine and a compressor, a pre-cleaner and a filter, characterized by:
an air amplifier having an inlet, a throat, a nozzle in the throat, and an outlet;
a first line communicating the inlet to a dirty air outlet of the pre-cleaner; and
a second line communicating compressed air from the compressor to the nozzle, the nozzle injecting compressed air into the throat and creating a suction which is communicated to the pre-cleaner via the first line.
